(19) United States
(12) Patent Application Publication
(10) Pub. No.: US 2005/0185047 A1
(43) Pub. Date: Aug. 25, 2005

(54) Method and apparatus for providing a combined image

(76) Inventor: Desmond Toh Onn Hii, Singapore (SG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/783,279

(22) Filed: Feb. 19, 2004

(51) Int. Cl. H04N 7/00

(52) U.S. Cl. 348/36

(57) ABSTRACT

Disclosed is a method for providing a combined image from a plurality of images each produced by one of a plurality of cameras. Each camera has an image system for taking an image of the plurality of images. The method comprises generating the plurality of images in each of the plurality of cameras and stitching the plurality of images to form the combined image using a stitcher disguised as a virtual camera.

### FIELD OF THE INVENTION

This invention relates to a method and apparatus for providing a combined image and refers particularly, though not exclusively, to such a method and apparatus for providing a combined image from a plurality of images.

### DEFINITIONS

Throughout this specification the use of “combined” is to be taken as including a reference to the creation of a panoramic image, as well as a stereoscopic image, lenticular stereoscopic image/video, and video post-production to merge two or more video image streams into a single video stream.

### BACKGROUND OF THE INVENTION

Panoramic images are images over a wide angle. In normal photography panoramic images are normally taken by having a sequence of successive images that are subsequently joined, or stitched together, to form the combined image. When the images are taken simultaneously using a plurality of cameras, the images are normally displayed separately. For video camera security, video conferencing, and other similar applications, this means multiple cameras, and multiple displays, must be used for continuous panoramic imaging.

Alternatively or additionally, one or more of the cameras may be a pan/tilt camera. This requires the pan/tilt cameras to have an operator to move the camera's field of vision, or a servomotor to move the camera. The servomotor may be operated remotely and/or automatically. However, when such a system is used, the camera is covering only a part of its maximum field of view at any one time. The consequence is that another part of its maximum field of view is not covered at any one time. This is unsatisfactory.

Although wide-angle lenses may be used to reduce the impact of the loss of coverage, the distortion introduced, particularly at higher off-axis angles, is also unsatisfactory. A wide-angle lens also requires a higher resolution image sensor to maintain the same resolution.

### SUMMARY OF THE INVENTION

In accordance with one aspect of the present invention there is provided a method for providing a combined image from a plurality of images each produced by one of a plurality of cameras each having an image system for taking an image of the plurality of images, the method comprising:
(a) generating the plurality of images in each of the plurality of cameras;
(b) stitching the plurality of images to form the combined image using a stitcher disguised as a virtual camera.

According to another aspect of the invention there is provided a method for providing a combined image from a plurality of images each produced by one of a plurality of cameras each having an image system for taking an image of the plurality of images, the method comprising:
(a) generating the plurality of images in each of the plurality of cameras;
(b) using a virtual camera to perform a stitching operation on the plurality of images to form the combined image.

According to a further aspect of the invention there is provided a method for providing a combined image from a plurality of images each produced by one of a plurality of cameras each having an image system for taking an image of the plurality of images, the method comprising:
(a) generating the plurality of images in the plurality of cameras;
(b) warping each of the plurality of images into an intermediate co-ordinate; and
(c) stitching the plurality of images into the combined image using a two dimensional search, stitching being by a stitcher disguised as a virtual camera.

In accordance with yet another aspect of the invention there is provided a method for providing a combined image from a plurality of images each produced by one of a plurality of cameras, each of the plurality of cameras having an image system for taking an image of the plurality of images, the method comprising:
(a) generating the plurality of images in each of the plurality of cameras;
(b) performing overlap calculations to determine overlap regions of the plurality of images;
(c) stitching the plurality of images to form the combined image; and
(d) using the results of step (b) for all subsequent pluralities of images from the plurality of cameras.

In accordance with an additional aspect of the invention there is provided a method for providing a combined image from a plurality of images each produced by one of a plurality of cameras each having an image system for taking an image of the plurality of images, the method comprising:
(a) generating the plurality of images in each of the plurality of cameras;
(b) selecting a presentation style for the combined image; and
(c) stitching the plurality of images to form the combined image in the presentation style, stitching being by a stitcher disguised as a virtual camera.

In accordance with a further additional aspect of the invention there is provided a method of producing a combined video image from a plurality of video images each produced by one of a plurality of video cameras each having an image system for taking an image of the plurality of images, the method comprising:
(a) warping each of the plurality of video images into an intermediate co-ordinate;
(b) determining overlap regions of the warped plurality of video images;
(c) stitching the warped plurality of video images to form the combined video image, stitching being by a stitcher disguised as a virtual camera; and
(d) processing the combined video image for one or more of: display and storage.

A penultimate aspect of the invention provides a method for providing a combined image from a plurality of images each produced by one of a plurality of cameras each having an image system for taking an image of the plurality of images, the method comprising the steps:
(a) generating the plurality of images in each of the plurality of cameras;
(b) performing overlap calculations to determine overlap regions of the plurality of images;
(a) using the overlap calculations to perform colour correction in the plurality of images; and
(b) performing substantially the same colour correction for all subsequent pluralities of images from the plurality of cameras.

A final aspect of the invention provides apparatus for providing a combined image, the apparatus comprising
(a) a plurality of cameras each having an image system;
(b) a stitcher for producing the combined image by performing a stitching operation on a plurality of images, each of the plurality of images being produced by one of the plurality of cameras; and
(c) the stitcher being disguised as a virtual camera.

Each camera may have a buffer, and they may be in a common body, or may be separate.

### BRIEF DESCRIPTION OF THE DRAWINGS

In order that the invention may be fully understood and readily put into practical effect, there shall now be described by way of non-limitative example only preferred embodiments of the present invention, the description being with reference to the accompanying illustrative drawings in which:

FIG. 1 is a perspective view of a preferred form of combined camera;

FIG. 2 is a perspective view of a second form of a combined camera;

FIG. 3 is a block diagram of the apparatus of FIGS. 1 and 2;

FIG. 4 is a flow chart of the virtual camera of FIG. 2; and

FIG. 5 is a representation of various presentation styles.

### DETAILED DESCRIPTION OF THE PREFERRED EMBODIMENTS

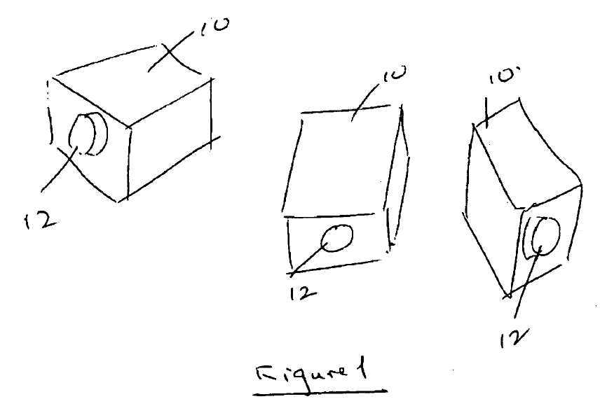

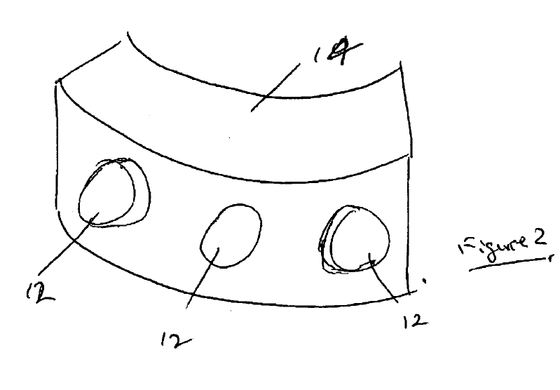

As shown in FIGS. 1 and 2, one approach to create a real-time combined video stream is to use multiple cameras 10. Although three are shown, this is for convenience. The number used may be any appropriate number from two up. If enough cameras were used, the field of view could be 360° in one plane. It could be spherical.

The image sensors 12 in a multiple-camera can either be separate entities as shown in FIG. 1, or combined into a single camera body 14 as shown in FIG. 2. Either way, each image sensor 12 of the multiple cameras provides a partial view of the target scene. Preferably the fields of view of each camera 10 overlaps with the field of view of the adjacent camera 10, and the video streams from each camera are stitched together using a stitcher into a single, combined video. If the cameras 10 are separate entities as shown in FIG. 1 they may be separate but relatively close as if in a cluster; or may be separate and remote from each other. If remote, it is still preferred for the fields of view to overlap.

As compared to a single camera with mechanical pan tilt motor, the multiple-camera configuration has the advantage of no moving parts which makes it free from mechanical failure. It has the additional benefit of capturing the entire scene all the time, behaving like a wide-angle lens camera, but without the associated distortion and loss of image data, particularly at wide, off-axis angles. Unlike a single wide-angle lens camera, which has a single image sensor, the multiple-camera configuration is scalable to wider view, and provides higher resolution due to the usage of multiple image sensors.

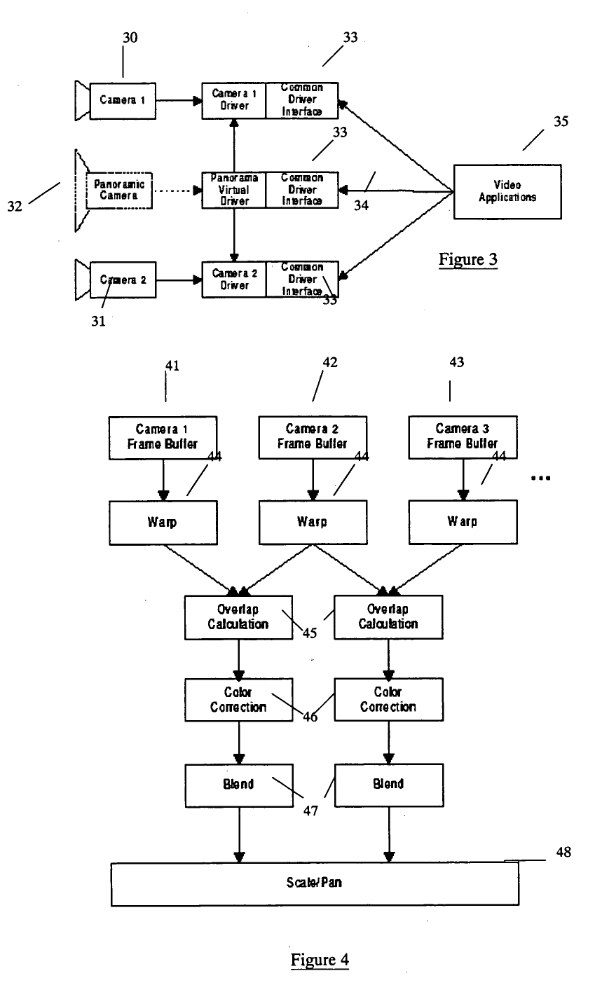

A multiple-camera system is useable using existing cameras and video applications, such as video conferencing and web casting applications, on a standard computer. In this way existing video applications can be used. One way for it to work with existing video applications is to disguise a stitcher as a virtual camera (FIG. 3) that can process the individual images from the cameras 10 to form the combined image, and present it to a generic video application. In this way special hardware and/or software may be avoided.

Most computer operating systems (OS) provide a standard method for its applications to access an attached camera. Typically, every camera has a custom “device driver”, which provides a common interface to which the OS can communicate. In turn, the OS provides a common interface to its applications for them to send queries and commands to the camera. Such layered architecture provides a standard way for the applications to access the cameras. Using a common driver interface is important for these applications to work independently of the camera vendor. It also enables these applications to continue to function with future cameras, as long as the cameras respect the common driver interface.

The virtual camera 32 does not exist in a physical sense. Instead of providing a video stream from an image sensor, which it lacks, the virtual camera 32 obtains the video streams 34 from other real cameras 30, 31 directly from their device drivers 33 or by using the common driver interface. It then combines and repackages these video streams into a single video stream, which it offers through its own common driver interface 33. A combined camera 32 is a virtual camera, which stitches the input video streams 34 into a combined video stream. As such the virtual camera 32 is a video processor capable of processing one or more input video streams, and outputs a single video stream.

From a video application's 35 perspective, the virtual camera 32 appears as a regular camera, with a wide viewing angle. In this way, the image data from more than one camera 30, 31 can be processed by the virtual camera 32 such that the computer's video application 35 sees it as a single camera. The number of cameras involved is not limited and may be two, three, four, five, six, and so forth. The panorama captured by their combined field of view is not limited and may extend to 360°, and even to a sphere.

As shown in FIG. 4, the combined virtual camera 32 is essentially a stitcher. In real time it takes overlapping images, one from each camera, and combines them into one combined image. The images come from the buffers 41, 42, 43 . . . from each camera 30, 31 . . . . Each image is warped (44) into an intermediate co-ordinate, such as the cylindrical or spherical co-ordinates, so that stitching can be reduced to a simple two-dimensional search. It then determines the overlap region of these images (45). Using the overlap region, colour correction can be performed (46) to ensure colour consistency across the images. The same colour correction, or substantially the same colour correction, is used for all subsequent images. The final images are then blended (47) together to form the final panorama.

To achieve real-time performance, the combined virtual camera performs the overlap calculation (45) only once, and assumes that the camera positions remain the same throughout the session.

Some video applications have format restriction. For example H.261 based video conferencing applications only accept CIF and QCIF resolution. The size and aspect ratio of the resulting combined image is likely to be different from the standard video formats. An additional stage to transform the image to the required format may also be performed, which typically involves scaling and panning.

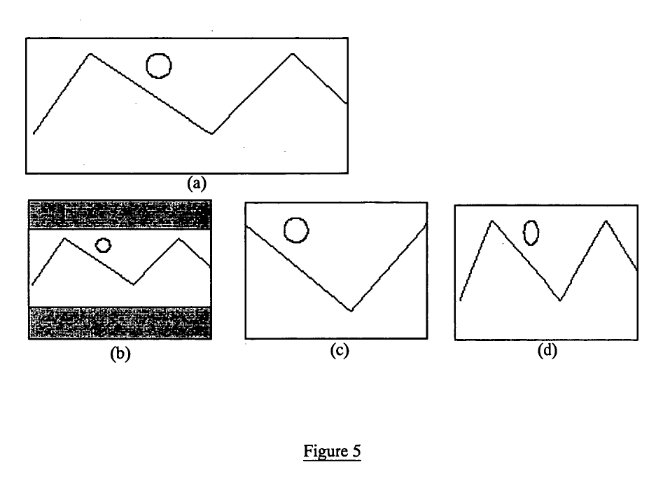

FIG. 5 illustrates a number of different presentation styles. FIG. 5(a) is the original combined image. The letterbox and pan & scan style of FIGS. 5(b) and 5(c) respectively resemble the approaches taken by the Digital Versatile Disc (DVD) format, to display a 16:9 image on a standard 4:3 display. The horizontal compression style of FIG. 5(d) may be useful for recording the combined video as it captures the entire view, at the expense of some loss in image detail.

A separate user interface may be provided to the user to enable the selection of different presentation styles. For pan & scan (48), the user can interactively pan the panorama to select a region of interest. Alternatively, automatic panning and switching between styles can be employed at pre-set time intervals. Multiple styles can also be created simultaneously. For example, the horizontal compressed style may be used for recording the video, while the pan & scan may be used for display.

By having multiple viewpoints, a perfect stitch may be possible. However, at the overlapping region, double or missing images may result. The problem may be more serious for near objects than distant objects. For surveillance application, which has mostly distant objects, the problems may be reduced. For close-up applications such as, for example, video conferencing, three cameras may be used so that the centre camera has the full picture of the human head and shoulder. Each camera should preferably send thirty frames each second.

For real-time stereoscopy, the virtual camera may perform the stereoscopic image formation such as, for example, by interlacing odd and even rows, and stacking the images for a top-to-bottom stereoscopy. For post-processing of video, the virtual camera may be used to combine or merge video from different cameras; and it may be used for the generation of lenticular stereoscopic image/video.

The virtual camera 32 is able to convert multiple video streams into a single stream in a stereo format by performing interlacing, resizing, and translation. Resizing is preferably performed with proper filtering such as, for example, “Cubic” and “Lanczos” interpolations for upsizing, and “Box” or “Area Filter” for downsizing. Row-interlace stereoscopy format interlaces the stereo pair with odd rows representing the left eye, and even rows representing the right eye. This can be viewed using de-multiplexing equipment such as, for example, “Stereographic's SimulEyes”, and that is compatible with standard video signals. The virtual camera 32 performs the interlacing, which involves copying pixels, and possibly resizing each line:
Line 1[—Left eye Line 1—]
Line 2[—Right eye Line 2—]
Line 3[—Left eye Line 3—]
Line 4[—Right eye Line 4—]

Above-Below stereoscopy format requires the vertically resizing and translation of the source images, the top for the left eye, and the bottom for the right eye. In the same way, the Side-by-Side format can also be used. In these cases, the virtual camera 32 performs scaling and translation to combine the two video streams into a single stereo video stream. At the receiving end, a device capable of decoding the selected format can be used to view the stereo pair using stereo glasses.

The cameras 10 may be digital still cameras, or digital motion picture cameras.

Whilst there has been described in the foregoing description a preferred embodiment of the present invention, it will be understood by those skilled in the technology that may variations or modifications in details of one or more of design, construction and operation maybe made without departing from the present invention.

1. A method for providing a combined image from a plurality of images each produced by one of a plurality of cameras each having an image system for taking an image of the plurality of images, the method comprising:
(a) generating the plurality of images in each of the plurality of cameras;
(b) stitching the plurality of images to form the combined image using a stitcher disguised as a virtual camera.

2. A method as claimed in claim 1, wherein stitching is by warping each of the plurality of images into an intermediate co-ordinate, and stitching the plurality of images into the combined image using a two dimensional search.

3. A method as claimed in claim 1, further comprising performing overlap calculations to determine overlap regions of the plurality of images, the overlap calculation being used for all subsequent pluralities of images from the plurality of cameras.

4. A method as claimed in claim 1, further comprising selecting a presentation style for the combined image.

5. A method as claimed in claim 3, further comprising selecting a presentation style for the combined image.

6. A method as claimed in claim 3, wherein stitching is by warping each of the plurality of images into an intermediate co-ordinate, and stitching the plurality of images into the combined image using a two dimensional search.

7. A method as claimed in claim 4, wherein stitching is by warping each of the plurality of images into an intermediate co-ordinate, and stitching the plurality of images into the combined image using a two dimensional search.

8. A method for providing a combined image from a plurality of images each produced by one of a plurality of cameras each having an image system for taking an image of the plurality of images, the method comprising:
(a) generating the plurality of images in each of the plurality of cameras;
(b) using a virtual camera to perform a stitching operation on the plurality of images to form the combined image.

9. A method as claimed in claim 8, wherein stitching is by warping each of the plurality of images into an intermediate co-ordinate, and stitching the plurality of images into the combined image using a two dimensional search.

10. A method as claimed in claim 8, further comprising performing overlap calculations to determine overlap regions of the plurality of images, the overlap calculation being used for all subsequent pluralities of images from the plurality of cameras.

11. A method as claimed in claim 10, further including:
(a) using the overlap calculations to perform colour correction in the plurality of images; and
(b) maintaining the colour correction for all subsequent pluralities of images from the plurality of cameras.

12. A method as claimed in claim 10, further comprising selecting a presentation style for the combined image.

13. A method as claimed in claim 11, further comprising selecting a presentation style for the combined image.

14. A method as claimed in claim 11, wherein stitching is by warping each of the plurality of images into an intermediate co-ordinate, and stitching the plurality of images into the combined image using a two dimensional search.

15. A method as claimed in claim 12, wherein stitching is by warping each of the plurality of images into an intermediate co-ordinate, and stitching the plurality of images into the combined image using a two dimensional search.

16. A method for providing a combined image from a plurality of images each produced by one of a plurality of cameras each having an image system for taking an image of the plurality of images, the method comprising:
(a) generating the plurality of images in each of the plurality of cameras;
(b) warping each of the plurality of images into an intermediate co-ordinate; and
(c) stitching the plurality of images into the combined image using a two dimensional search, stitching being by a stitcher disguised as a virtual camera.

17. A method as claimed in claim 16, further comprising performing overlap calculations to determine overlap regions of the plurality of images, the overlap calculation being used for all subsequent pluralities of images from the plurality of cameras.

18. A method as claimed in claim 16, further comprising selecting a presentation style for the combined image.

19. A method for providing a combined image from a plurality of images each produced by one of a plurality of cameras each having an image system for taking an image of the plurality of images, the method comprising:
(a) generating the plurality of images in each of the plurality of cameras;
(b) performing overlap calculations to determine overlap regions of the plurality of images;
(c) stitching the plurality of images to form the combined image, stitching being by a stitcher disguised as a virtual camera; and
(d) using the results of step (b) for all subsequent pluralities of images from the plurality of cameras.

20. A method as claimed in claim 19, wherein stitching is by warping each of the plurality of images into an intermediate co-ordinate, and stitching the plurality of images into the combined image using a two dimensional search.

21. A method as claimed in claim 19, further comprising selecting a presentation style for the combined image.

22. A method for providing a combined image from a plurality of images each produced by one of a plurality of cameras each having an image system for taking an image of the plurality of images, the method comprising:
(a) generating the plurality of images in each of the plurality of cameras;
(b) selecting a presentation style for the combined image; and
(c) stitching the plurality of images to form the combined image in the presentation style, stitching being by a stitcher disguised as a virtual camera.

23. A method as claimed in claim 22, wherein stitching is by warping each of the plurality of images into an intermediate co-ordinate, and stitching the plurality of images into the combined image using a two dimensional search.

24. A method as claimed in claim 22, further comprising performing overlap calculations to determine overlap regions of the plurality of images, the overlap calculations being used for all subsequent pluralities of images from the plurality of cameras.

25. A method of producing a combined video image from a plurality of video images each produced by one of a plurality of video cameras each having an image system for taking an image of the plurality of images, the method comprising:
(a) warping each of the plurality of video images into an intermediate co-ordinate;
(b) determining overlap regions of the warped plurality of video images;
(c) stitching the warped plurality of video images to form the combined video image, stitching being by a stitcher disguised as a virtual camera; and
(d) processing the combined video image for one or more of: display and storage.

26. A method as claimed in claim 25, further comprising performing overlap calculations to determine overlap regions of the plurality of images, the overlap calculations being used for all subsequent pluralities of images from the plurality of cameras.

27. A method as claimed in claim 25, further comprising selecting a presentation style for the combined image.

28. A method for providing a combined image from a plurality of images each produced by one of a plurality of cameras each having an image system for taking an image of the plurality of images, the method comprising:
(a) generating the plurality of images in each of the plurality of cameras;
(b) performing overlap calculations to determine overlap regions of the plurality of images;
(c) using the overlap calculations to perform colour correction in the plurality of images; and
(d) performing substantially the same colour correction for all subsequent pluralities of images from the plurality of cameras.

29. A method as claimed in claim 28, wherein stitching is by warping each of the plurality of images into an intermediate co-ordinate, and stitching the plurality of images into the combined image using a two dimensional search.

30. A method as claimed in claim 28, further comprising selecting a presentation style for the combined image.

31. A method as claimed in claim 28, wherein stitching is by a stitcher disguised as a virtual camera.

32. A method as claimed in claim 29, further comprising selecting a presentation style for the combined image.

33. A method as claimed in claim 30, further comprising selecting a presentation style for the combined image.

34. A method as claimed in claim 29, wherein stitching is by a stitcher disguised as a virtual camera.

35. Apparatus for producing a combined image, the apparatus comprising:
(a) a plurality of cameras each having an image system;
(b) a stitcher for performing a stitching operation on a plurality of images, each of the plurality of images being produced by one of the plurality of cameras, to produce the combined image;
(c) the stitcher being disguised as a virtual camera.

36. Apparatus as claimed in claim 35, wherein each camera includes a buffer.

37. Apparatus as claimed in claim 35, wherein the plurality of cameras is in a common body.

38. Apparatus as claimed in claim 35, wherein each of the plurality of cameras is in a separate body.
